(19) United States
(12) Patent Application Publication
(10) Pub. No.: US 2014/0208034 A1
(43) Pub. Date: Jul. 24, 2014

(54) System And Method for Efficient Paravirtualized OS Process Switching

(71) Applicant: WIND RIVER SYSTEMS, INC., Alameda, CA (US)

(72) Inventors: Dennis RICE, San Francisco, CA (US); Mark Dapoz, Kanata, CA (US); Raymond Richardson, Richmond, CA (US)

(73) Assignee: Wind River Systems, Inc., Alameda, CA (US)

(21) Appl. No.: 13/744,899

(22) Filed: Jan. 18, 2013

(51) Int. Cl. G06F 12/08

(52) U.S. Cl. CPC G06F 12/084; G06F 12/0891
USPC 711/130; 711/135

(57) ABSTRACT

The exemplary embodiments described herein relate to systems and methods for improved process switching of a paravirtualized guest with a software-based memory management unit (“MMU”). One embodiment relates to a non-transitory computer readable storage medium including a set of instructions executable by a processor, the set of instructions, when executed, resulting in a performance of the following: create a plurality of new processes for each of a plurality of virtual environments, each of the virtual environments assigned one of a plurality of address space identifiers (“ASIDs”) stored in a cache memory, perform a process switch to one of the virtual environments thereby designating the one of the virtual environments as the active virtual environment, determine whether the active virtual environment has exhausted each of the ASIDs, and flush a cache memory when it is determined that the active virtual environment has exhausted each of the ASIDs.

### BACKGROUND

Virtual operating environments are used for a wide variety of purposes. Software operating in such environments may request access to devices for the same purposes as software running in any other type of computing environment. However, in the virtualization context, the devices requested in this manner may not actually be resident on the computing system, but may themselves be virtualized. Accordingly, virtualization is used to create a virtual version of a component such as a hardware platform, operating system (“OS”), storage device, or network resources. Thus, a virtual machine (“VM”) is implemented as a simulation of a machine, either abstract or real, that may be different from the machine in which it is being simulated on. VMs may be based on specifications of a hypothetical computer or emulate the architecture and functioning of a real world computer.

Furthermore, “paravirtualization” is a virtualization technique that presents a software interface to virtual machines that is similar but not identical to that of the underlying hardware. Paravirtualization allows for multiple operating systems to run on hardware at the same time by making more efficient use of system resources (e.g., processors and memory) through effective resource sharing. Specifically, the intent of this modified interface is to reduce the portion of a guest's execution time spent performing operations that are substantially more difficult to run in a virtual environment compared to a non-virtualized environment. Unlike full virtualization, wherein an entire system is emulated, the management module of the paravirtualization environment (e.g., a hypervisor or virtual machine monitor) operates with an operating system that has been modified to work in a virtual machine.

### SUMMARY

The exemplary embodiments described herein relate to systems and methods for improved process switching of a paravirtualized guest with a software-based memory management unit (“MMU”). One embodiment relates to a non-transitory computer readable storage medium including a set of instructions executable by a processor, the set of instructions, when executed, resulting in a performance of the following: create a plurality of new processes for each of a plurality of virtual environments, each of the virtual environments assigned one of a plurality of address space identifiers (“ASIDs”) stored in a cache memory, perform a process switch to one of the virtual environments thereby designating the one of the virtual environments as the active virtual environment, determine whether the active virtual environment has exhausted each of the ASIDs, and flush a cache memory when it is determined that the active virtual environment has exhausted each of the ASIDs.

A further embodiment relates to a system, comprising a shared cache memory, a plurality of virtual environments each of the virtual environments assigned one of a plurality of address space identifiers (“ASIDs”) stored in the shared cache memory, and a hypervisor creating a plurality of new processes for each of the plurality of virtual environments, performing a process switch to one of the virtual environments thereby designating the one of the virtual environments as the active virtual environment, determining whether the active virtual environment has exhausted each of the ASIDs, and flushing a cache memory when it is determined that the active virtual environment has exhausted each of the ASIDs.

A further embodiment relates to a method, comprising creating, by a hardware hypervisor, a plurality of new processes for each of a plurality of virtual environments, each of the virtual environments assigned one of a plurality of address space identifiers (“ASIDs”) stored in a cache memory, performing, by the hardware hypervisor, a process switch to one of the virtual environments thereby designating the one of the virtual environments as the active virtual environment, determining, by the hardware hypervisor, whether the active virtual environment has exhausted each of the ASIDs, and flushing, by the hardware hypervisor, a cache memory when it is determined that the active virtual environment has exhausted each of the ASIDs.

### BRIEF DESCRIPTION OF THE DRAWINGS

FIG. 1 shows an exemplary embodiment of a system for improved process switching of a paravirtualized guest according to the exemplary embodiments described herein.

FIG. 2 shows an exemplary embodiment of a method for improved process switching of a paravirtualized guest according to the exemplary embodiments described herein.

### DETAILED DESCRIPTION

The exemplary embodiments may be further understood with reference to the following description and the appended drawings, wherein like elements are referred to with the same reference numerals. The exemplary embodiments described herein relate to systems and methods for efficient paravirtualized operating system (“OS”) process switching. Specifically, the exemplary embodiments relate to systems and methods for improved process switching of a paravirtualized guest with a software-based memory management unit (“MMU”).

Within a paravirtualized environment, a hypervisor may be described as a program executed by a processor of a computing system that is capable of utilizing a portion of the resources of the computing system (e.g., processing resources, memory) to virtualize the performance of a different type of computing system having different capabilities than the computing system itself. In addition, a hypervisor may include a virtual memory management unit (“VMMU”) to manage memory allocated to virtual processors.

The exemplary hypervisor may manage one or more virtual processors. Each virtual processor may execute its own operating system (or “guest operating system”), and each guest operating system may manage multiple programs (also known as processes), each with its own virtual memory context. To achieve good performance, the hypervisor may maintain a cached set of page tables for the virtual memory context of each guest operating system. Each time a virtual processor switches between two MMU contexts, the hypervisor may switch between the two corresponding page tables instead of rebuilding new page tables. The hypervisor will be described in greater detail below.

According to the exemplary embodiments, the systems and methods described herein will improve process switching of a paravirtualize guest within a software based MMU. As will be described in greater detail below, the various improvements include reducing the number of calls to the hypervisor, allowing multiple processes in a guest to simultaneously be in the a translation lookaside buffer (“TLB”) cache, abstracting hardware identifiers from the guest, supporting a guest OS, etc. Thus, these features will provide noticeable performance improvements to the hypervisor, while reducing the gap between native and paravirtualized guest OS performance on the same hardware.

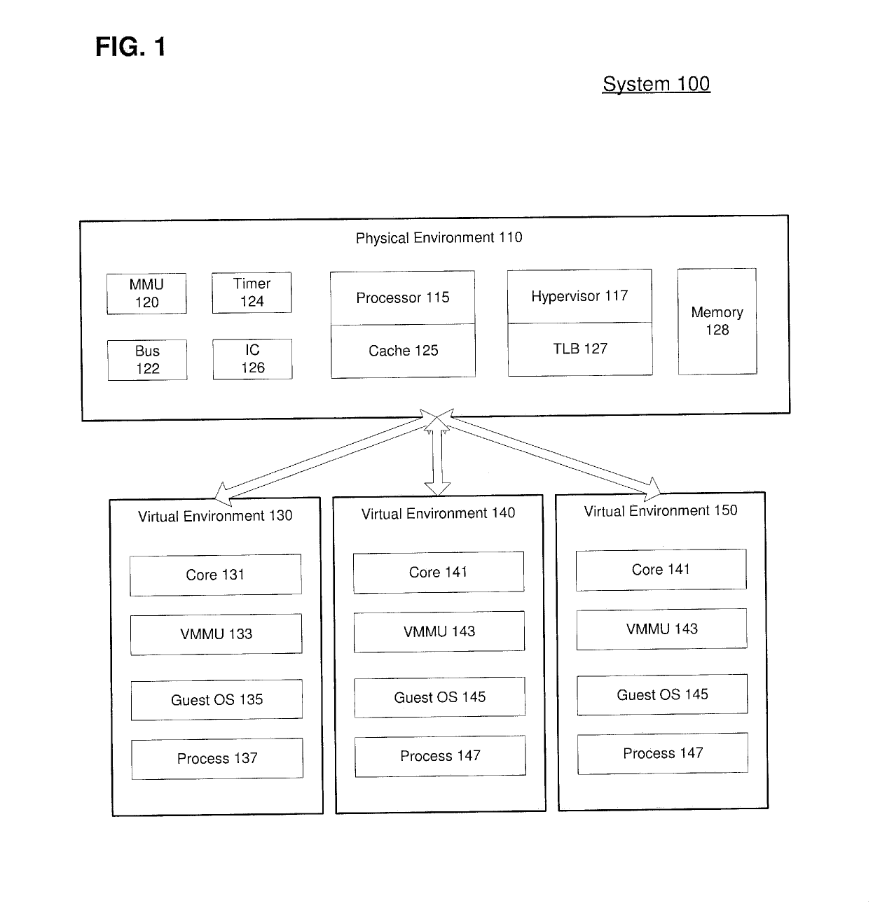

FIG. 1 illustrates an exemplary system 100 for efficient paravirtualized OS process switching with a software based MMU according to the present invention. The system 100 includes a physical environment 110 (e.g., a physical board) that includes a processor 115 which may be any type of processor capable of executing instructions contained in code, firmware, etc. A processor may concurrently execute and run multiple processes. Those skilled in the art will understand that a processor may include multiple cores (or there may be multiple processors) that independently execute various tasks. The present invention is equally applicable to such arrangements, but for the sake of simplicity, the exemplary embodiments are described with reference to a single processor.

In addition, the physical environment 110 also includes other components such as a memory management unit (“MMU”) 120, a bus 122, a timer 124, an interrupt controller 126, a memory 128, and a processor cache 125. These additional components provide the physical environment with various other functionalities that may be required to perform the processes and tasks required by executing software applications. Those skilled in the art will understand that components may be deleted from the physical environment 110 or other components may also be included on the physical environment 110, as needed. Examples of additional components may include an Ethernet interface, a serial interface, etc.

The system 100 also includes a plurality of virtual environments 130, 140 and 150. The virtual environments 130, 140, 150 each include a plurality of virtual components including, virtual processing cores, virtual memories, virtual timers, virtual interrupt controllers and virtual MMU (“VMMUs”) 133, 143, 153. Each of the virtual components may be mapped to a corresponding physical component on the physical environment 110. In addition, each virtual environment 130, 140, 150 is running an operating system 135, 145, 155 and an application program or process 137, 147, 157. As shown in FIG. 1, each virtual environment 130, 140 and 150 includes the same virtual components. However, those skilled in the art will understand that the virtual environments 130, 140, 150 may include any number of virtual components and the purpose of the virtual environments is to emulate an actual physical environment without the developer needing the actual physical environment. That is, a single physical environment 110 may be used to emulate any number of other physical environments. Thus, the use of three virtual environments is also only exemplary.

In the exemplary embodiment of FIG. 1, the processor 115 is used to emulate a number of virtual processors 131, 141, 151 (also referred to herein as “guests”), each of which may be dedicated to its own guest operating system. Those skilled in the art will understand that since the processing cores 131, 141, 151 are virtual, the information about these processors may be stored in the physical memory 128 of the physical environment 110. The processor 115 may also implement software that enables the processor 115 to manage the process of switching between tasks. In this exemplary embodiment, such software is referred to as a hypervisor 117. The virtual processors 131, 141, 151 may run any of the various tasks that a computing device may need to execute (e.g., read/write operations, print operations, calculations, other processing, etc.). These virtual processors 131, 141, 151 may also share access to the other resources of the physical environment 110, e.g., the MMU 120, the bus 122, the timer 124, the interrupt controller 126 and the memory 128. As stated above, the MMU 120 and the hypervisor 117 may manage the virtual processors 131, 141, 151 and control the switching process so that no errors or damage occur due to an inconveniently timed switch.

It should be noted that throughout this description, it will be described that the virtual environments 130, 140, 150 gain access to the resources of the physical environment 110. It should be understood that this access is transparent to the software being executed by the virtual environments 130, 140, 150. That is, the software (e.g., operating systems, applications, etc.) will understand the virtual environments 130, 140, 150 to be actual physical environments and the virtual resources of the virtual environments 130, 140, 150 to be actual resources. The software will not be aware that the physical environment with its resources is what is actually executing the software.

The hypervisor 117 may further include a translation lookaside buffer (“TLB”) 127 to serve as a cache that memory management hardware may used to improve virtual address translation speed. Specifically, the TLB 127 may be used to map virtual and physical address spaces within the system 100. An exemplary TLB 127 may be used to map both virtual and physical address spaces. The TLB 127 may include a fixed number of slots that contain page table entries that map virtual addresses to physical addresses, wherein the virtual memory is the space seen from a process. This space may be segmented in pages of a prefixed size. The page table of the TLB 127 may be loaded in memory in order to record where the virtual pages are loaded in the physical memory. Thus, the TLB 127 may be described as a cache of the page table that may store a subset of its contents.

The exemplary TLB 127 may reference physical memory addresses within its table. Furthermore, while the TLB 127 is depicted in FIG. 1 as residing within the hypervisor 117, the TLB 127 may reside between the processor 115 and a processor cache 125, between the processor cache 125 and primary storage memory 128, between levels of a multi-level cache, etc. Accordingly, the placement of the TLB 127 may be used to determine whether the cache uses physical or virtual addressing. If the cache is physically addressed, the processor 115 may execute a TLB lookup on every memory operation and the resulting physical address is then sent to the cache 125. If the cache 125 is virtually addressed, requests may be sent directly from the processor 115 to the cache 125 and the TLB 127 may only be accessed on a cache miss. It should be noted that if the cache 125 uses virtual addressing, the cache 125 may include an address space identifier (“ASID”). However, caches that do not include ASIDs may be flushed at every context switch in such a multiprocessing environment as depicted in system 100.

One of the features of the improved paravirtualized OS process switching is the reduction of the number of calls to the hypervisor 117. Previously vmmuConfig/Enable and context load were called for the hypervisor. In addition, calls were required for internally flushing the TLB cache. In contrast, the exemplary system 100 create/delete application programming interfaces (“API's”) may only be called once per guest process. Furthermore, a context load hypercall may be used only as the API requires for switching between active processes. Also, the TLB cache flush may only be required when a guest wants to reuse virtual ASIDs.

A further feature of the improved paravirtualized OS process switching is that the exemplary system 100 makes use of multiple hardware process identifiers thereby allowing for multiple processes of a guest to be in the TLB cache at the same time.

The exemplary system 100 also provides virtual ASIDs to abstract the hardware ASIDs from a guest. Accordingly, the mapping of the virtual ASID to the hardware ASID may then be implementation dependent.

Furthermore, the exemplary system 100 allows for a guest OS kernel to be treated as a process with a virtual ASID. Accordingly, this would allow for the hypervisor 117 to support a guest OS that may utilize very large TLBs for flat kernel mapping (e.g., Linux PPC), or variable kernel mapping (e.g., vxWorks PPC). The hypervisor 117 may support such a guest OS while maintaining protection between the guest process and guest kernel. Specifically, the hypervisor provides integrity against faulty data in any one of the plurality of virtual environments.

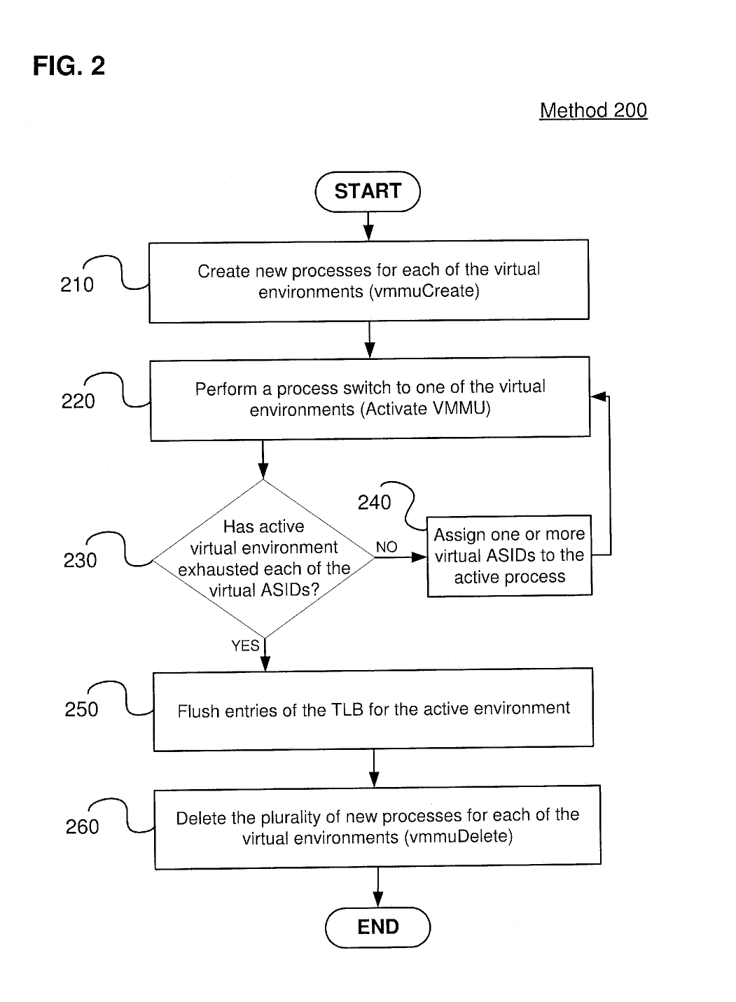

FIG. 2 shows an exemplary embodiment of a method 200 for improved process switching of a paravirtualized guest with a software based MMU according to the exemplary embodiments described herein according to the exemplary embodiments described herein. It should be noted that the exemplary method 200 will be discussed with reference to the processing system 100 of FIG. 1. Accordingly, the method 200 allows for an operating system, such as the processing system 100, to provide efficient paravirtualized OS process switching. Furthermore, the exemplary method 200 may be performed over a computer OS, such as, but not limited to, a Linux-based OS.

In step 210, the exemplary system 100 may create a plurality of new processes for each of the virtual environments 130, 140, 150. For instance, the hypervisor 117 may execute a (vmmuCreate) instruction to create these new processes. As noted above, the create/delete APIs may be called only once for each guest process. In addition, each of the virtual environments 130, 140, 150 may be assigned one of a plurality of virtual ASIDs abstracted from hardware ASIDs. Accordingly, a guest OS kernel may be treated as one of the created process having a virtual ASID.

In step 220, the exemplary system 100 may perform a process switch to one of the virtual environments 130, 140, 150. For instance, the hypervisor 117 may execute a (Activate VMMU) instruction to switch processes to an active process. A process switch may occur any time that the operating system has gained control from the currently running process. A context load hypercall may be used as only API required for switching between active processes.

In step 230, the exemplary system 100 may determine whether currently active virtual environment (e.g., guest) has exhausted each of the virtual ASIDs stored in the TLB 127. If it has been determined that the guest has not exhausted each of the virtual ASIDs, then the exemplary method 200 may advance to step 240. However, if it has been determined that the virtual ASIDs have been exhausted, then the exemplary method 200 may advance to step 250.

In step 240, the exemplary system 100 may assign one or more virtual ASIDs to the active process. Once the ASID is assigned to the process, the exemplary method 200 may return to step 220 wherein the VMMU of the guest is activated.

In step 250, the exemplary system 100 may flush the virtual ASIDs. For instance, the system 100 may effectively flush entries of the TLB 127 for a specific guest by allocating a new ASID for the guest and not reusing the old ASID until the entire TLB has been flushed at least once. Accordingly, the system 100 may only require to flush the TLB 127 when a guest requests the reuse of virtual ASIDs.

In step 260, the exemplary system 100 may delete the plurality of new processes for each of the virtual environments 130, 140, 150. For instance, the hypervisor 117 may execute a (vmmuDelete) instruction to delete these new processes.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A non-transitory computer readable storage medium including a set of instructions executable by a processor, the set of instructions, when executed, resulting in a performance of the following:
create a plurality of new processes for each of a plurality of virtual environments, each of the virtual environments assigned one of a plurality of address space identifiers (“ASIDs”) stored in a cache memory;
perform a process switch to one of the virtual environments thereby designating the one of the virtual environments as the active virtual environment;
determine whether the active virtual environment has exhausted each of the ASIDs; and
flush a cache memory when it is determined that the active virtual environment has exhausted each of the ASIDs.

2. The non-transitory computer readable storage medium of claim 1, wherein the execution of the set of instructions further results in the performance of the following:
delete the plurality of new processes for each of a plurality of virtual environments.

3. The non-transitory computer readable storage medium of claim 1, wherein the cache memory is a translation lookaside buffer.

4. The non-transitory computer readable storage medium of claim 1, wherein only one create application programming interface is called per virtual environment.

5. The non-transitory computer readable storage medium of claim 1, wherein a context load hypercall is used as only application programming interface required for switching to the active virtual environment.

6. The non-transitory computer readable storage medium of claim 1, wherein each of the virtual environments includes a guest operating system and the process is a kernel of the guest operating system.

7. The non-transitory computer readable storage medium of claim 1, wherein the process switching is performed by a hypervisor providing integrity against faulty data in any one of the plurality of virtual environments.

8. The non-transitory computer readable storage medium of claim 1, wherein the execution of the set of instructions further results in the performance of the following:
utilize multiple ASIDs allowing for multiple guest processes simultaneously within the cache memory.

9. The non-transitory computer readable storage medium of claim 1, wherein mapping of virtual ASIDs to hardware ASIDs is implementation dependent.

10. A system, comprising:
a shared cache memory;
a plurality of virtual environments each of the virtual environments assigned one of a plurality of address space identifiers (“ASIDs”) stored in the shared cache memory; and
a hypervisor creating a plurality of new processes for each of the plurality of virtual environments, performing a process switch to one of the virtual environments thereby designating the one of the virtual environments as the active virtual environment, determining whether the active virtual environment has exhausted each of the ASIDs, and flushing a cache memory when it is determined that the active virtual environment has exhausted each of the ASIDs.

11. The system of claim 10, wherein the hypervisor further deletes the plurality of new processes for each of a plurality of virtual environments.

12. The system of claim 10, wherein the cache memory is a translation lookaside buffer.

13. The system of claim 10, wherein only one create application programming interface is called per virtual environment.

14. The system of claim 10, wherein a context load hypercall is used as only application programming interface required for switching to the active virtual environment.

15. The system of claim 10, wherein each of the virtual environments includes a guest operating system and the process is a kernel of the guest operating system.

16. The system of claim 10, wherein the hypervisor provides integrity against faulty data in any one of the plurality of virtual environments.

17. The system of claim 10, wherein the hypervisor further utilizes multiple ASIDs allowing for multiple guest processes simultaneously within the cache memory.

18. The system of claim 10, wherein mapping of virtual ASIDs to hardware ASIDs is implementation dependent.

19. A method, comprising:
creating, by a hardware hypervisor, a plurality of new processes for each of a plurality of virtual environments, each of the virtual environments assigned one of a plurality of address space identifiers (“ASIDs”) stored in a cache memory;
performing, by the hardware hypervisor, a process switch to one of the virtual environments thereby designating the one of the virtual environments as the active virtual environment;
determining, by the hardware hypervisor, whether the active virtual environment has exhausted each of the ASIDs; and
flushing, by the hardware hypervisor, a cache memory when it is determined that the active virtual environment has exhausted each of the ASIDs.

20. The method of claim 19, further comprising:
deleting the plurality of new processes for each of a plurality of virtual environments.
